(19) United States
(12) Patent Application Publication
(10) Pub. No.: US 2004/0226305 A1
(43) Pub. Date: Nov. 18, 2004

(54) Machine for dispensing icy beverages

(75) Inventor: Enrico Grampassi, Cervia (IT)

Correspondence Address: MODIANO & ASSOCIATI, Via Meravigli, 16, MILANO, 20123, IT

(73) Assignee: SPM DRINK SYSTEMS S.R.L.

(21) Appl. No.: 10/843,475

(22) Filed: May 12, 2004

(30) Foreign Application Priority Data
May 16, 2003 (IT) MO2003A000143

(51) Int. Cl. A23G 9/00; F25C 1/00; B67D 5/56

(52) U.S. Cl. 62/135; 62/343

(57) ABSTRACT

A machine for dispensing icy beverages such as slushes, sorbets and the like, particularly coffee-flavored ones, comprising at least one tank for containing an icy beverage, provided with at least one inlet and at least one outlet, elements for agitating the beverage, which are arranged inside the tank, and at least one refrigeration system provided with an evaporation unit associated with the tank, and elements for sensing and controlling the temperature of the beverage contained in the tank, which are functionally associated with the refrigeration system.

The present invention relates to a machine for dispensing icy beverages such as slushes, sorbets and the like, particularly coffee-flavored ones.

### BACKGROUND OF THE INVENTION

It is known that machines for dispensing icy beverages such as slushes and sorbets have been used for years in public places such as bars, ice-cream parlors and restaurants.

These dispensing machines are substantially constituted by at least one tank for containing the beverage to be served, which is provided with an inlet and an outlet for said beverage, and with a refrigeration system in which the evaporation unit is associated with said tank and is suitable to keep the beverage inside it at a chosen consistency.

Paddle agitator means are usually provided inside the tank and keep the beverage in motion, so as to adjust its fluidity and prevent the separation of any components that have a different specific gravity.

Known dispensing machines are further provided with sensing means for measuring physical values that are proportional to the fluidity of the beverage contained within the tank, such as for example viscosity; the sensing means are associated with a microswitch that switches on and off the compressor of the refrigeration system.

The agitator means are constituted by a spiral-shaped set of paddles, which is rotationally actuated by a motor shaft that is supported so that it can rotate and oscillate; the mixing contrast force discharged by the beverage onto the set of paddles, which is proportional to the consistency of said beverage, causes the oscillation of the motor shaft with respect to the tank.

The sensing means are generally of the mechanical type and are constituted by elastic springs for contrasting the oscillation of the motor shaft, which are preloaded so as to keep the shaft in position until the contrast offered by the beverage reaches values that indicate a consistency that is too dense with respect to the intended one.

In normal conditions, i.e., when the consistency of the beverage is close to the intended one, said shaft keeps the microswitch in the configuration in which the compressor is on.

When the beverage instead starts to become too dense, the contrast offered against mixing increases until it overcomes the action of the spring; the motor shaft can therefore oscillate, disengaging said microswitch and switching off the compressor of the refrigeration system.

However, said sensing means generally have a low sensitivity and their efficiency is greatly influenced by the quantity of beverage that is contained inside the tank.

The value of the contrast discharged onto the motor shaft for which the compressor should be switched off is in fact proportional to the volume and therefore to the mass of beverage that is present inside the tank.

Therefore, as the quantity of beverage contained in the tank varies, it would be necessary to adjust appropriately the preloading of the contrast spring.

As an alternative, dispensing machines are also known in which the rpm rate of the motor shaft that actuates the set of paddles changes when the consistency of the beverage contained in the tank varies.

When said rpm rate drops until it reaches a set threshold value, the refrigeration system is switched off.

These known dispensing machines are not free from drawbacks, including the fact that sometimes they do not allow to maintain, and therefore serve, the beverages in optimum conditions of consistency (more or less dense beverage) and of uniform mixing of the components inside it.

This fact inevitably has a negative effect on the satisfaction index of the consumer with respect to the beverages, which can have a visually unpleasant appearance.

In the case of slushes, sorbets or other products, particularly coffee-flavored ones, preserving the beverages in inadequate temperature and mixing conditions forms, inside the tank, icy flocks that have different colors depending on their coffee content.

The beverage contained in the tank therefore assumes an unpleasant appearance, which makes it look like an old and poorly preserved product, because a gradual stratification of the color can be noted.

### SUMMARY OF THE INVENTION

The aim of the present invention is to eliminate the above-mentioned drawbacks of known dispensing machines, by providing a machine for dispensing icy beverages such as slushes, sorbets and the like, particularly coffee-flavored ones, that allows to preserve the beverages in optimum conditions, so as to serve them with the correct consistency, temperature and mixing.

Within this aim, an object of the present invention is to provide a dispensing machine that is simple, relatively easy to provide in practice, safe in use, effective in operation, and has a relatively low cost.

This aim and this and other objects that will become better apparent hereinafter are achieved by the present machine for dispensing icy beverages such as slushes, sorbets and the like, particularly coffee-flavored ones, comprising at least one tank for containing an icy beverage which is provided with at least one inlet and at least one outlet for said beverage, means for agitating said beverage, which are arranged inside said tank, and at least one refrigeration system provided with an evaporation unit associated with said tank, characterized in that it comprises means for sensing and controlling the temperature of the beverage contained in said tank which are functionally associated with said refrigeration system.

### BRIEF DESCRIPTION OF THE DRAWINGS

Further characteristics and advantages of the present invention will become better apparent from the following detailed description of a preferred but not exclusive embodiment of a machine for dispensing icy beverages such as slushes, sorbets and the like, particularly coffee-flavored ones, illustrated by way of non-limiting example in the accompanying drawings, wherein:

FIG. 1 is a schematic front view of the dispensing machine according to the invention;

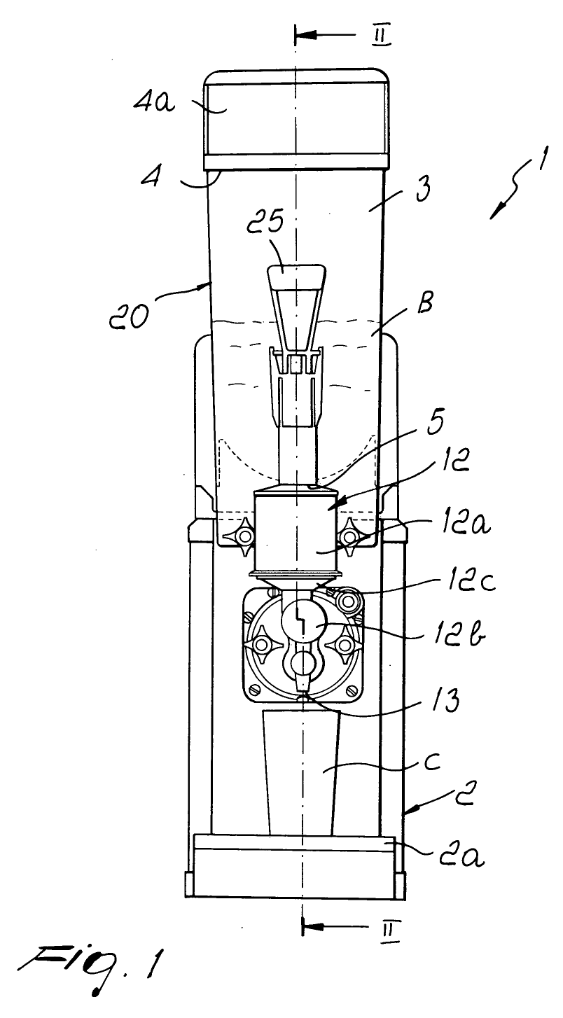

FIG. 2 is a schematic sectional view, taken along the longitudinal line II-II of FIG. 1, of the machine according to the invention.

### DESCRIPTION OF THE PREFERRED EMBODIMENTS

With reference to the figures, the reference numeral 1 designates a machine for dispensing icy beverages such as slushes, sorbets and the like, particularly coffee-flavored ones.

The machine 1 comprises a footing 2 for supporting a tank 3 for containing an icy beverage B, which is provided with an inlet 4 and an outlet 5 for said beverage.

The inlet 4 is formed by the upper opening of the tank 3 and is closed by a detachable lid 4a; the outlet 5 is arranged proximate to the bottom of the tank 3, at the front wall of said tank.

A conventional refrigeration system RS is further accommodated inside the footing 2, and its evaporation unit EU is associated with the tank 3 and is suitable to remove heat from said tank, so as to keep the beverage B at a chosen temperature.

Such evaporation unit EU comprises a substantially tubular body 6, which is arranged proximate to the bottom of the tank 3 and is arranged so that one end 6a is located at the outlet 5 and so that its longitudinal axis A is inclined, with respect to a horizontal plane, and rises toward said outlet.

Means 7 for agitating the beverage B are provided inside the tank 3 and may be of a conventional type, constituted by a spiral-shaped set of paddles 8, which winds around the lateral surface of the body 6 and is supported, by the very body 6, so that it can rotate about a rotation axis that coincides with said longitudinal axis of the tubular body 6.

The set of paddles 8 is rotationally actuated by motor means 9, which are not shown in detail because they are of a conventional type, and are accommodated inside the footing 2.

The direction of rotation of the set of paddles 8 is such as to propel the beverage B contained inside the tank 3 toward the end 6a of the body 6 and therefore toward the outlet 5.

The machine 1 further comprises means 10 for sensing and controlling the temperature of the beverage B, which are functionally associated with the refrigeration system RS.

The sensing and control means 10 comprise a probe 11, preferably of the electronic type, which is covered with a waterproof protection made for example of stainless steel.

Advantageously, the probe 11 is supported by the end 6a of the body 6 at the outlet 5 and proximate to the bottom of the tank 3.

It should be noted that in this manner the probe 11 is arranged in a region of the tank 3 where the beverage B is always present thanks to the action of the set of paddles 8.

The probe 11 is therefore always at least partially immersed in the beverage B.

The sensing and control means 10 further comprise means for adjusting the refrigeration system, which are constituted by a programmable management unit PMU of the electronic type, that may be of a conventional type, and is associated in input with the probe 11 and in output with the compressor of the refrigeration system RS.

The management unit reads in input the data acquired by the probe 11, compares them with a set threshold value, and depending on the outcome of this comparison adjusts the operation of the compressor of the refrigeration system.

If the probe 11 measures a temperature of the beverage B that is lower than the set temperature, the management unit acts on the compressor, reducing the heat removed from the tank 3 by the evaporation unit of the refrigeration system, or by switching off the compressor.

The probe 11 allows to appreciate few temperature variations of the beverage B and therefore adjust precisely the operation of the refrigeration system by means of the management unit.

Conveniently, the machine 1 comprises a chamber 12 for collecting the beverage B, which is connected to the tank 3 through the outlet 5 and is provided with a dispensing outlet 13 for said beverage.

The chamber 12 is arranged below the tank 3 at the front part of said tank.

Advantageously, the machine 1 further comprises means 14 for mixing the beverage B in output from the tank 3, which are accommodated inside the chamber 12.

The mixing means 14 are constituted by a rotating element 15, which is supported so that it can rotate about a rotation axis X that preferably lies transversely to the flow of the beverage B inside the chamber 12 and is associated with corresponding rotary actuation means 16, which are accommodated within the footing 2.

The rotating element 15 is composed of a shaft 17, which is arranged at said rotation axis and has an end that is associated with the actuation means 16 and an opposite end that is supported so as to protrude inside the chamber 12 and is provided with paddles 18.

By way of the mixing means 14 it is therefore possible to serve a blended or “shaker-mixed” beverage B without requiring the aid of any further tool or electrical appliance.

The machine 1 therefore allows to obtain said beverages in a practical manner and quickly, and its use is particularly effective in the case of beverages B such as slushes, sorbets and the like having a coffee flavor.

The chamber 12 is constituted by a first portion 12a for receiving the beverage B, which is connected to the tank 3 through the outlet 5, and by a second portion 12b, inside which the rotating element 15 is accommodated.

The first portion 12a is arranged above the second portion 12b and the dispensing outlet 13 is arranged at the bottom of the second portion 12b.

A funnel-shaped connecting portion 12c is provided between the portions 12a and 12b and is arranged so that it tapers toward the second portion 12b.

Below the dispensing outlet 13, the footing 2 is provided with a bracket 2a for supporting a container C, such as a cup or the like, in which the beverage B is served.

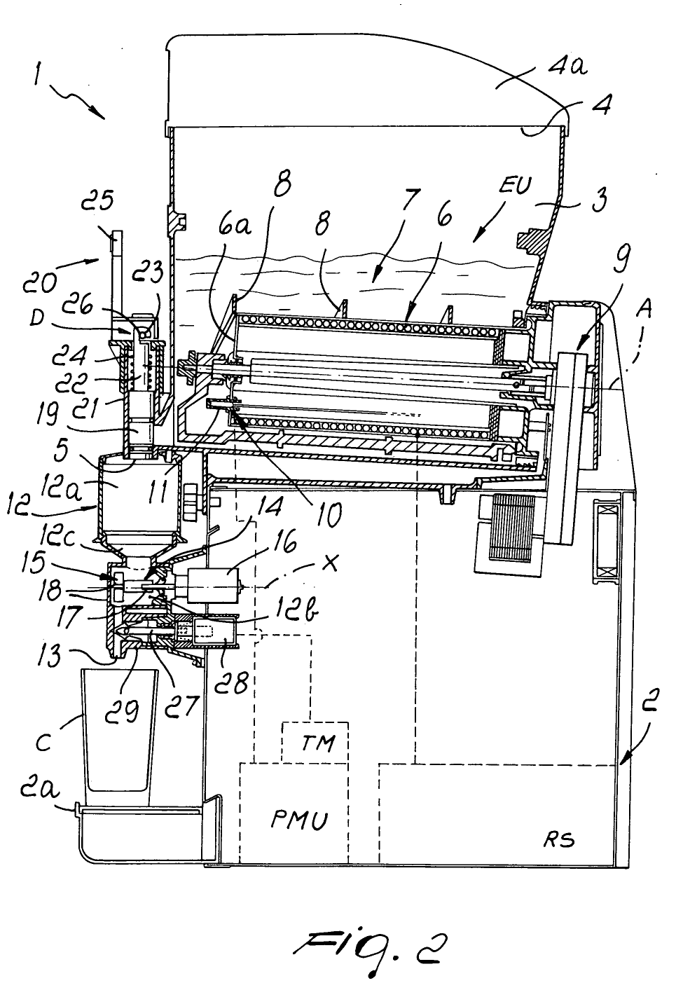

The outlet 5 is provided with an associated first flow control element 19, which can move alternately between positions corresponding to a closed configuration (FIG. 2) and an open configuration of said outlet and is operatively connected or associated with first actuation means 20.

The first flow control element 19 is arranged substantially vertically and is accommodated so that it can slide within a seat 21 that is rigidly coupled to the tank 3.

A stem 22 is associated above the first flow control element 19 and protrudes upward from the seat 21; a slot 23 is provided in its upper end.

A helical compression spring 24 is fitted on the stem 22, and its lower and upper ends are arranged in abutment, respectively, against the first flow control element 19 and against the upper wall of the seat 21.

The first actuation means 20 may be constituted by a lever 25, which is pivoted above the seat 21 and is provided with a pivot 26 that is inserted in the slot 23.

The rotation of the lever 25 actuates the sliding of the first flow control element 19 along the seat 21 and the consequent opening of the outlet 5; the spring 24 then facilitates the return of the first flow control element 19 into the closed configuration.

In the particular embodiment shown, the first actuation means 20 are of the manual type, and the rotation of the lever 25 must therefore be actuated by an operator.

As an alternative, the first actuation means 20 might be of an automatic type and optionally be associated with dosage means D, that are of a conventional type, and which are suitable to adjust the quantity of beverage B that exits from the tank 3.

The first actuation means 20 of the automatic type may have, for example, means for the automatic movement of the lever 25.

The dispensing outlet 13 is associated with a second flow control element 27, which can move alternately between a closed configuration (FIG. 2) and an open configuration of the dispensing outlet 13 and is associated with second actuation means 28.

The second flow control element 27 is accommodated so that it can slide along a horizontal seat 29 that is monolithically associated with the front wall of the footing 2.

In the particular embodiment shown, the second actuation means 28 are of the automatic type and are constituted by a conventional fluid-operated actuator that is associated with the second flow control element 27 and acts in a horizontal direction.

However, alternative embodiments of the machine 1, in which for example the second actuation means 28 are of the manual type, are not excluded.

Conveniently, the machine 1 can have timer means TM which activate sequentially the operation of the mixing means 14 for a set time interval and activate the subsequent opening of the dispensing outlet 13 by way of the second actuation means 28.

If the first actuation means 20 are of the automatic type, said timer means can adjust their operation.

In practice it has been found that the described invention achieves the intended aim and object.

In particular, the machine according to the invention allows to provide precise and prompt control and adjustment of the temperature of the beverage to be served and not of its consistency, regardless of the quantity of beverage contained in the tank.

Moreover, by arranging the probe proximate to the outlet of the tank it is possible to obtain a temperature measurement that is always reliable and correct.

The invention thus conceived is susceptible of numerous modifications and variations, all of which are within the scope of the appended claims.

All the details may further be replaced with other technically equivalent ones.

In practice, the materials used, as well as the shapes and dimensions, may be any according to requirements without thereby abandoning the scope of the protection of the appended claims.

The disclosures in Italian Patent Application No. MO2003A000143 from which this application claims priority are incorporated herein by reference.

What is claimed is:

1. A machine for dispensing flavored icy beverages, comprising: at least one tank for containing an icy beverage, which is provided with at least one inlet and at least one outlet for said beverage; agitation means for agitating said beverage, which are arranged inside said tank; at least one refrigeration system provided with an evaporation unit associated with said tank; sensing and control means for sensing and controlling temperature of the beverage contained in said tank, said sensing and control means being functionally connected with said refrigeration system.

2. The machine of claim 1, wherein said sensing and control means comprise at least one probe that is at least partially immersed in the beverage contained inside said tank.

3. The machine of claim 1, wherein said sensing and control means comprise adjustment means for adjusting said refrigeration system.

4. The machine of claim 1, wherein said sensing and control means are of a substantially electronic type.

5. The machine of claim 2, wherein said probe is arranged proximate to a bottom of said tank.

6. The machine of claim 5, wherein said probe is located proximate to said tank outlet.

7. The machine of claim 6, wherein said evaporation unit comprises a substantially tubular body, which is supported proximate to the bottom of said tank and has an end that is arranged at said tank outlet; and said agitation means comprise a set of paddles that is rotatably supported on a lateral surface of said tubular body, and motor means for rotationally actuating said set of paddles, with a direction of rotation of the set of paddles being such as to propel the beverage toward the tank outlet; and said probe is associated with said tubular body at said body end.

8. The machine of claim 6, wherein said adjustment means comprise a programmable management unit, which is connected to said probe in input and to said refrigeration system in output, the management unit being adapted to adjust operation of the refrigeration system depending on a temperature sensed by said probe.

9. The machine of claim 1, comprising at least one beverage collection chamber, which is connected to said tank through said tank outlet and is provided with at least one dispensing outlet for said beverage.

10. The machine of claim 9, wherein said chamber is arranged below said tank.

11. The machine of claim 10, comprising further: a first actuation means; and a first flow control element, which is provided at said tank outlet, so as to move alternately between positions corresponding to an open configuration and a closed configuration of said tank outlet, said first flow control element being operatively connected with said first actuation means.

12. The machine of claim 11, wherein said first actuation means are of a manual actuated type.

13. The machine of claim 11, wherein said first actuation means are of a substantially automatic actuated type.

14. The machine of claim 13, comprising dosage means, which are associated with said first automatic actuation means for adjusting a quantity of beverage that exits from said tank.

15. The machine of claim 14, comprising: second actuation means; and a second flow control element, which is operatively connected with said dispensing outlet, said second flow control element being movable alternately between positions corresponding to an open configuration and a closed configuration of said dispensing outlet, following to actuation thereof by way of said second actuation means.

16. The machine of claim 15, wherein said second actuation means are of a manual actuation type.

17. The machine of claim 15, wherein said second actuation means are of a substantially automatic actuation type.

18. The machine of claim 15, comprising mixing means for mixing the beverage in output from said tank, said mixing means being accommodated inside said chamber.

19. The machine of claim 18, wherein said mixing means comprise at least one rotating element, which is supported so as to rotate inside said chamber.

20. The machine of claim 19, wherein said rotating element rotates about a rotation axis arranged substantially transversely to a flow of the beverage through said chamber.

21. The machine of claim 18, wherein said chamber comprises a first portion for receiving the beverage in output from said tank, which is connected to said tank through said tank outlet, and a second portion for accommodating said mixing means, which is associated with said dispensing outlet, said first and second portions being mutually connected.

22. The machine of claim 21, wherein said chamber comprises a substantially funnel-shaped connecting portion, which is interposed between said first and second chamber portions.

23. The machine of claim 22, wherein said first chamber portion is arranged above said second chamber portion, said dispensing outlet being arranged proximate to a bottom of the second portion.

24. The machine of claim 19, comprising timer means that are suitable to operate sequentially said mixing means and said second actuation means for opening said dispensing outlet.

25. The machine of claim 24, wherein said timer means are operatively associated with said first automatic actuation means.
